(19) United States
(12) Patent Application Publication
(10) Pub. No.: US 2015/0091703 A1
(43) Pub. Date: Apr. 2, 2015

(54) SYSTEMS AND METHODS OF USING A READABLE SAFETY TAG

(71) Applicant: Michael P. Buono, III, Wayne, PA (US)

(72) Inventor: Michael P. Buono, III, Wayne, PA (US)

(21) Appl. No.: 14/500,684

(22) Filed: Sep. 29, 2014

Related U.S. Application Data
(60) Provisional application No. 61/883,223, filed on Sep. 27, 2013.

(51) Int. Cl. G06K 7/10; G06F 17/30

(52) U.S. Cl. CPC G06K 7/10386; G06F 17/30386; G06F 17/30091
USPC 340/10.4

(57) ABSTRACT

A safety tag network communication method is provided that comprises receiving, from an electronic device, a first communication having identifier information identifying a tag user, the identifier information being disposed on a tag accompanying the tag user. The method also includes identifying, via a computer, one or more portions of safety information in a database associated with the identifier information disposed on the tag. The one or more portions of safety information are associated with the tag user. The method also includes retrieving, via a computer, the one or more portions of safety information associated with the tag user from the database. The method further includes transmitting, to the electronic device, a second communication having the one or more portions of safety information associated with the tag user and providing the one or more portions of retrieved safety information associated with the tag user at the electronic device.

### CROSS REFERENCE TO RELATED APPLICATIONS

This application claims priority to U.S. Provisional Patent Application No. 61/883,223, filed on Sep. 27, 2013 and entitled Systems And Methods Of Using A Readable Safety Tag, the contents of which are included in their entirety by reference herein.

### TECHNOLOGY FIELD

The present application relates generally to methods, systems, and apparatuses for a safety tag communication network, and in particular, to methods, systems, and apparatuses for presenting tag user safety information, such as medical information, emergency contact information and physician contact information, that is associated with identifier information on safety tags.

### BACKGROUND

Injuries are on the rise in youth sports leagues. Very few leagues regulate on-site attendance of medical professionals, such as people having first aid certification or CPR certification, during games or practices. There are many games, practices or other events when there are no medically trained professionals present on-site to handle injuries, such as broken bones, concussions and allergic reactions. Further, many coaches or other on-site personnel lack medical equipment or tools to handle more difficult injuries and medical conditions (e.g., diabetic seizures, food allergies and asthma attacks). In some cases, medical information (e.g., emergency contact information, allergies and medical conditions) is provided by parents or legal guardians to parties, such as league officials (e.g., via forms). This medical information is not often present or otherwise not easily accessible by coaches and on-site personnel when needed (e.g., injuries or other occurrence of medical condition).

### SUMMARY

Embodiments provide a computer implemented safety tag network communication method that includes receiving, from an electronic device, a first communication having identifier information identifying a tag user. The identifier information is disposed on a tag accompanying the tag user. The method also includes identifying, via a computer, one or more portions of safety information in a database associated with the identifier information disposed on the tag. The one or more portions of safety information are associated with the tag user. The method also includes retrieving, via a computer, the one or more portions of safety information associated with the tag user from the database and transmitting, to the electronic device, a second communication having the one or more portions of safety information associated with the tag user. The method further includes providing the one or more portions of retrieved safety information associated with the tag user at the electronic device.

According to one embodiment, the method also includes associating, via the computer, the one or more portions of safety information with the identifier information and storing, in the database, the identifier information and the one or more portions of safety information associated with the identifier information.

According to another embodiment, receiving the communication from the first electronic device further includes a request for the one or more portions of the safety information associated with the tag user.

In one embodiment, the safety information associated with the tag user includes at least one of: (i) electronic medical records; (ii) emergency contact information; (iii) physician contact information; and (iv) insurance information.

In yet another embodiment, the safety tag identifier includes at least one of the tag user's name and a safety tag identification number identifying the tag user.

According to one embodiment, receiving the first communication having the identifier information further includes receiving the identifier information obtained automatically from the tag by the electronic device.

In one aspect of an embodiment, the safety tag identifier includes a bar code and the identifier information is obtained automatically from the tag by the electronic device via the bar code.

In another aspect of an embodiment, the safety tag identifier includes radio frequency identification (RFID) and the identifier information is obtained automatically from the tag by the electronic device via the RFID.

According to one embodiment, receiving the first communication having the identifier information further includes receiving the identifier information manually input to the electronic device.

According to another embodiment, the communication method further includes receiving the safety tag user's name and the one or more portions of safety information via a web based server.

Embodiments provide a safety tag information network communication system that includes a safety tag configured to accompany a tag user and having identifier information disposed on a portion of the safety tag, the identifier information identifying the tag user. The system also includes an electronic device configured to transmit the identifier information via a network and present the one or more portions of tag user safety information associated with the identifier information. The system further includes a system server that includes: (i) a receiving module configured to receive the identifier information from the electronic device; (ii) a database interface module configured to retrieve the one or more portions of the tag user safety information associated with the identifier information; and (iii) a transmitting module configured to transmit the one or more portions of the tag user safety information associated with the identifier information to the electronic device.

According to one embodiment, the electronic device further includes a display module configured to display the one or more portions of the tag user safety information associated with the identifier information.

According to another embodiment, the system further includes an electronic database configured to hold the identifier information and the one or more portions of the tag user safety information associated with the identifier information.

In one embodiment, the server further includes a computer configured to identify the one or more portions of the tag user safety information associated with the identifier information in the electronic database.

In another embodiment, the system further includes a web based server configured to receive the one or more portions of the safety tag user's name and the one or more portions of safety information and provide the one or more portions of the safety tag user's name and the one or more portions of safety information to the system server.

In an aspect of an embodiment, the server further includes a computer configured to associate the one or more portions of safety information with the identifier information and cause the identifier information and the one or more portions of safety information associated with the identifier information to be stored in an electronic database.

Embodiments provide a safety tag for use with a safety tag network communication system. The safety tag is configured to accompany a safety tag user and includes an identifier portion that includes identifier information that identifies the safety tag user and is associated with safety information of the safety tag user.

According to one embodiment, the identifier information includes at least one of the safety tag user's name and a safety tag identification number identifying the tag user.

According to another embodiment, the identifier information includes a bar code and the identifier information is obtained automatically from the tag by the electronic device via the bar code.

In yet another embodiment, the identifier information includes radio frequency identification (RFID) and the identifier information is obtained automatically from the tag by the electronic device via the RFID.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a system block diagram illustrating a safety tag communication system for use with embodiments disclosed herein;

FIG. 2 is a system diagram illustrating elements of components of the safety tag network communication system for use with embodiments disclosed herein;

FIG. 3 is a screen shot illustrating emergency contact information displayed on an electronic device according to embodiments disclosed herein;

FIG. 4 is a screen shot illustrating medical information displayed on electronic device embodiments disclosed herein;

FIG. 5 shows a series of screen shots on an electronic device illustrating an exemplary method of accessing and displaying safety information according to one or more embodiments;

FIG. 6 is a screen shot of a family homepage for a family having multiple children tag users according to embodiments disclosed herein;

FIG. 7 is an illustration of an exemplary safety tag for use with embodiments disclosed herein;

FIG. 8 is an illustration of the safety tag attached to a helmet according to embodiments disclosed herein; and

FIG. 9 illustrates an example of a computing environment within which embodiments of the invention may be implemented.

### DESCRIPTION OF EXEMPLARY EMBODIMENTS

Embodiments of the invention may include a safety tag, having a readable code (e.g., Quick Response (QR) Code) and/or a tag number or player name, which may be linked to a database over a network. The database may provide a coach or other on-site personnel with access to stored identifiable safety information (e.g., electronic medical records, insurance information, emergency contact numbers, and physician information) to more efficiently treat illnesses or injuries.

Embodiments provide, a medical information network communication system which includes a web-based application or web site that is used to communicate, store and display safety information corresponding to uniquely identifiable safety tag identifiers (e.g., safety tag number, name, barcode) for each tag user (e.g., child). The stored safety information may be linked to the safety tag identifiers, allowing youth sports, clubs, camps and schools to map tag users (e.g., players, scouts, students) with on-site personnel or entities (e.g., coaches, troop leaders and school). In some embodiments, the communication system may provide efficient access to HIPPA protected medical information and their emergency contact numbers when the tag users are injured or are in need of medical intervention (e.g., concussion, spinal injury, broken bones, allergic reactions, seizures and insect bites and stings). Embodiments may include automatically reading (e.g., swiping or scanning) the readable code and/or manually entering readable code. In some embodiments, an indication (e.g., logs, alerts) of the event may be sent to a party or entity, such as a parent, a coach and/or a league. In some embodiments, a visual dashboard may be provided to parties (e.g., parents, guardians) to manage each safety tag number linked to associated safety tag users (children, students, players and scouts).

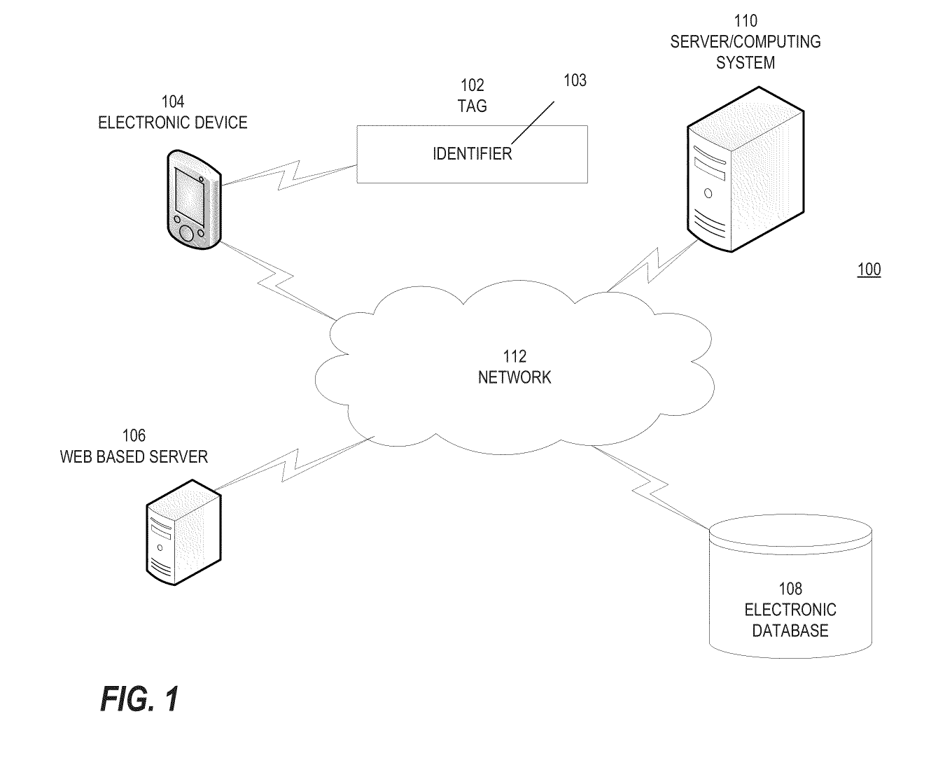

FIG. 1 is a system block diagram illustrating a safety information network communication system 100 for use with embodiments disclosed herein. As shown in FIG. 1, the system 100 may include a safety tag 102, an electronic device 104, a web based server 106, an electronic database 108, a server/computing system 110 and a network 112.

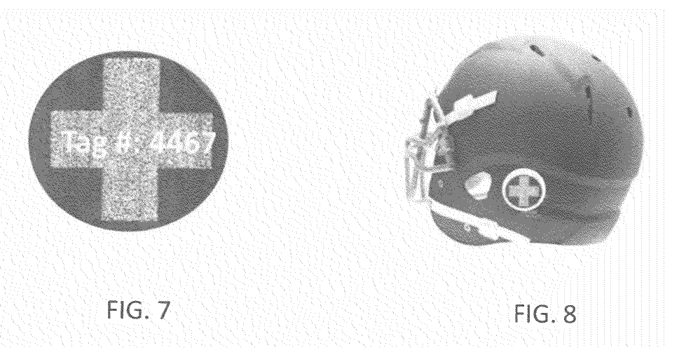

Safety tag 102 may accompany a safety tag user (not shown). For example, the safety tag 102 may accompany the safety tag user via articles worn by the safety tag users (e.g., coupled to or attached to clothing, sporting equipment and bracelets) or attached to the users themselves (e.g., permanent or temporary tattoos, adhesive stickers). An example of a safety tag 102 is shown in FIG. 7. An example of a safety tag 102 accompanying the tag user via sporting equipment is shown in FIG. 8. As shown in FIG. 8, the safety tag 102 is attached to a helmet 802. Other embodiments may include safety tags attached to other types of equipment.

The tag 102 may include a safety tag identifier 103 having identifier information (e.g., tag user's name or identification number that identifies the tag user). The identifier 103 may also include a code, such as a bar code or radio frequency identification (RFID) that includes the identifier information.

The electronic device 104 may be configured to send the identifier information of identifier 103 over network 112, receive safety information associated with the identifier information on the tag and present (e.g., display or aurally provide) the safety information to a user of the electronic device. The safety information may include, but is not limited to electronic medical records (e.g., allergies, injuries, blood type, medical conditions, height, and weight), emergency contact information, physician contact information, insurance information and permission to treat. In some embodiments, the electronic device 104 may include a bar code reader or an RFID reader to read the information indicated by the identifier 103. In other embodiments, the user (e.g., coach, on-site personnel) of electronic device 104 may view the identifier information and manually input the identifier information into the electronic device 104, which may then be sent over network 112.

The electronic device 104 may be any electronic device configured to transmit, receive and display text and data (e.g., images). Examples of electronic device 104 include any mobile device (e.g., smart phone, personal digital assistant (PDA), a tablet computer) and may also include a personal computer (laptop or desktop) or a network computer. For simplification purposes, the exemplary system 100 shown in FIG. 1 includes a single electronic device and a single tag. Other embodiments may include systems having any number of tags including identifier information and any number of electronic devices configured to transmit, receive and display text and data over network 112.

Electronic database 108 may be any medium that includes any medical information associated with any tag user and any corresponding identifier information. For example, data in the electronic database 108 may include medical information associated with the user of tag 102 and the information of identifier 103.

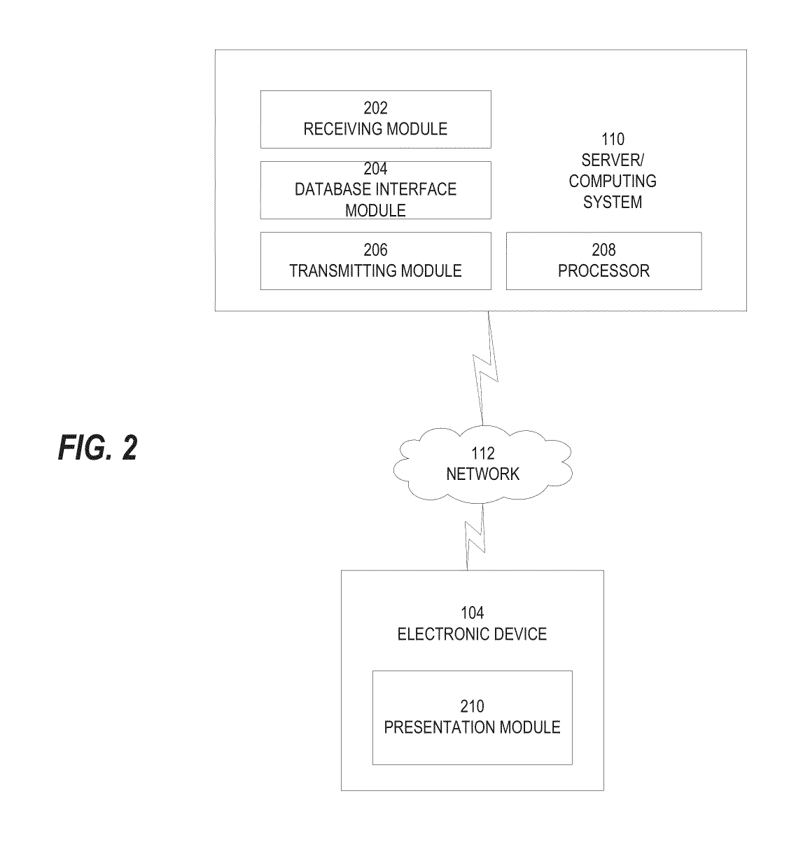

FIG. 2 is a diagram illustrating elements of server/computing system 110, and electronic device 104 of the communication system 100 shown in FIG. 1 for use with embodiments disclosed herein. As shown in FIG. 2, server/computing system 110 may include receiving module 202, database interface module 204, transmitting module 206 and processor 208. In some embodiments, server/computing systems may include more than one processor. Receiving module 202 may be configured to receive data, via network 112, from electronic device 104 and other electronic devices. Database interface module 204 may be configured to associate one or more portions of a tag user's electronic medical records with identifier information included in communications received at receiving module 202. Transmitting module 202 may be configured to transmit data, via network 112, to electronic device 104 and other electronic components of system 100. Electronic device 104 may include a presentation module 210 configured to provide (e.g., display) information to a user of the electronic device 104.

An exemplary safety tag network communication method is now described with reference to FIG. 1 and FIG. 2. The exemplary method describes a single tag and communications between a single electronic device 104 and other components of system 100. Embodiments may, however, include methods having communications from any number of electronic devices and using any number of tags.

The safety information of a tag user (e.g., child) may be associated with the identifier information that identifies the user of tag 102 via safety information network communication system 100. For example, in some embodiments, a person (e.g., user, parent, coach, league official) having knowledge of the tag user's safety information may input the safety tag user's name and the user's safety information via a web site or mobile application using web based server 106. The input safety information may then be associated with identifier information (e.g., safety tag number and/or user's name) via processor 208, of server/computing system 110. The safety tag 102 that includes the associated identifier information may then be provided to the safety tag user. In other embodiments, the safety tag 102 may have a pre-assigned safety tag identifier (e.g., number) and may be provided to a tag user prior to linking the identifier information with the safety information. The safety tag identifier from the provided safety tag 102 along with the name of the safety tag user and the safety information may then be input at the web site or a mobile application, thereby linking the safety tag identifier with the safety information of the tag user.

In some embodiments, the web site or a mobile application may include a registration and a log in step (e.g., via a user name and password) to input any information. In some embodiments, a user may input the information at a web site or mobile application provided for a group or organization (e.g., local youth sports organization, a league, local scouts group). Information may be updated by accessing the web site or a mobile application at any time.

After the tag user's safety information is associated with identifier information that identifies the tag user, the safety information and the associated identifier information may be stored, in electronic database 108 and may later be obtained via network 112. For example, when the identifier information and safety information has been input using the web site or mobile application, the identifier information and safety information may be sent via web based server 106 and network 112 to receiving module 202 of server/computing system 110. The safety information and the associated identifier information may be stored, via database interface module 204, in electronic database 108.

Thereafter, the identifier information on the identifier 103 of safety tag 102 may be sent to server/computing system 110 using electronic device 104 to obtain the safety information associated with the tag user of safety tag 102. For example, an electronic device user (e.g., coach of child) may access the safety tag website or mobile application using web based server 106 and send the identifier information on the identifier 103. The identifier information may be observed and manually sent or read and sent automatically (e.g., via bar code or RFID). The safety tag 102 may also include the login information (e.g., user name and password) of the tag user to access the website or mobile application. The electronic device user may also access the website or mobile application using their own login information.

The identifier information may be sent, by the electronic device 104 via a communication that includes the identifier information, to receiving module 202 of server/computing system 110 via network 112. Server/computing system 110 may then identify, via processor 208, the identifier information and retrieve, via database interface module 204, one or more portions of the safety information corresponding to the identifier information in electronic database 108. Server/computing system 110 may then transmit, via transmitting module 206, the one or more portions of the safety information corresponding to the identifier information to the electronic device 104 for presentation (e.g., display) using web based server 106. The one or more portions of the safety information may then be presented on electronic device 104, via presentation module 210. The presentation module 210 may include any software used to provide safety information (e.g., software to provide electronic medical records such as HIPPA protected medical information) on a display of an electronic device, including, but not limited to mobile device applications, web pages and desk top software.

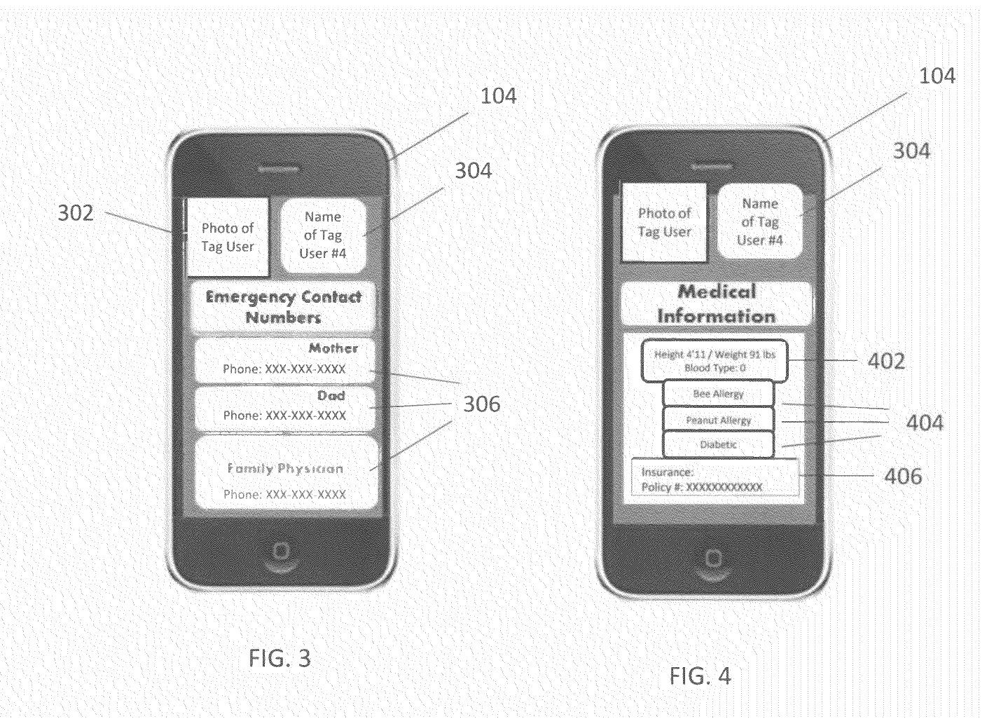

As described above, safety information of a tag user may include electronic medical records emergency contact information and physician contact information. FIG. 3 and FIG. 4 show screen shots illustrating exemplary safety information that may be displayed on an electronic device, such as electronic device 104 shown in FIG. 1.

FIG. 3 is a screen shot illustrating emergency contact information displayed on electronic device 104. As shown in FIG. 3, an emergency contact information display may include a picture 302 of a tag user, a name and identification number display area 304 and emergency contact information 306.

FIG. 4 is a screen shot illustrating medical information displayed on electronic device 104. As shown in FIG. 4, a medical information display page may include the picture of a tag user 302, a name and identification number of the tag user 304, physical information of the tag user 402, medical conditions of the tag user 404 and insurance information 406.

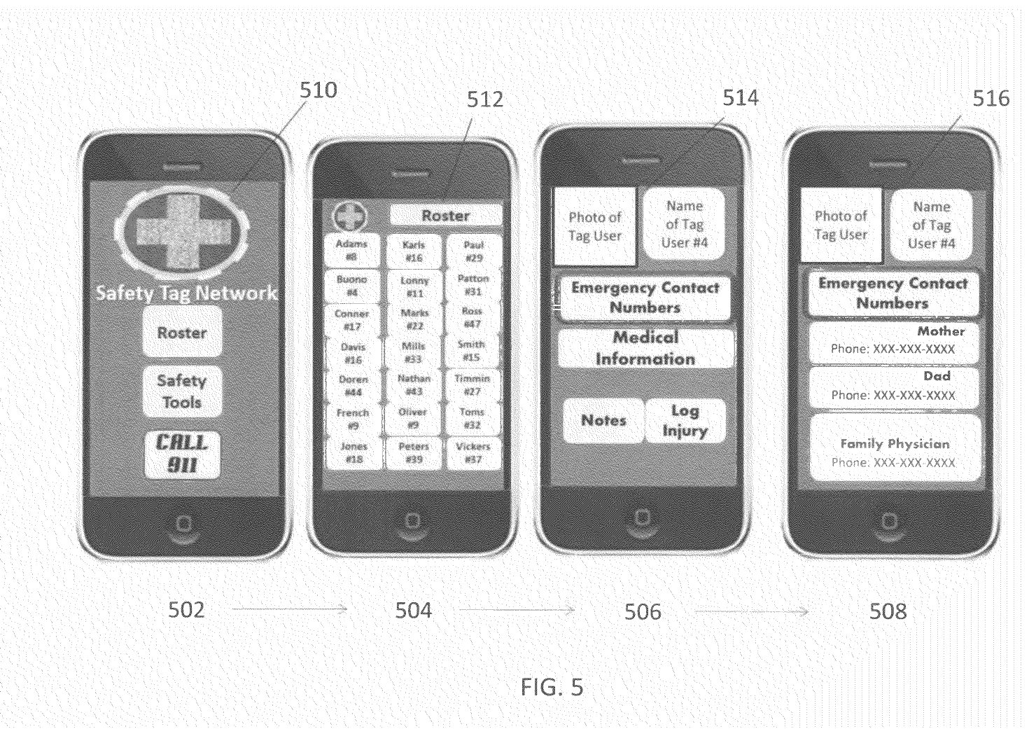

FIG. 5 shows a series of screen shots on an electronic device 104 illustrating an exemplary method of accessing and displaying safety information according to one or more embodiments. The series of screen shots shown in FIG. 5 may, for example, illustrate displays on an electronic device of a coach of a youth sports team. For example, as shown at step 502, a home page 510 of a safety tag network may be displayed on a coach's electronic device 104. As shown in the home page 510, a plurality of selections 512 may be displayed. For example, the selections may include: a selection to display a team roster page 512, a selection to display a safety tools page (not shown) and a selection to call 911 when the electronic device is a mobile phone device.

When a selection to display a roster of the team is chosen, a team roster page 512 may be displayed as shown at step 504. As shown in the team roster page 512, a plurality of player selections 512 may be displayed. In the embodiment shown in the team roster page 512, each of the player selections may display names and identification numbers of each player (tag user). Embodiments may, however, display other types of information.

When a selection to display an individual player is chosen, a player information page 514 may be displayed as shown at step 506. As shown in the player information page 514, a plurality of selections may be displayed that include a selection to display emergency contact information page (shown in FIG. 3), a selection to display the medical information page 516, a selection to display a notes page (not shown), and a selection to display an injury log page (not shown).

When a selection to display the medical information is chosen, the medical information page 516 may be displayed as shown at step 508. The medical information page 516 is also shown in FIG. 4 and described above with reference to FIG. 4. The method described with reference to FIG. 5 is merely exemplary. Embodiments may include other methods of navigating pages in safety tag web sites or applications.

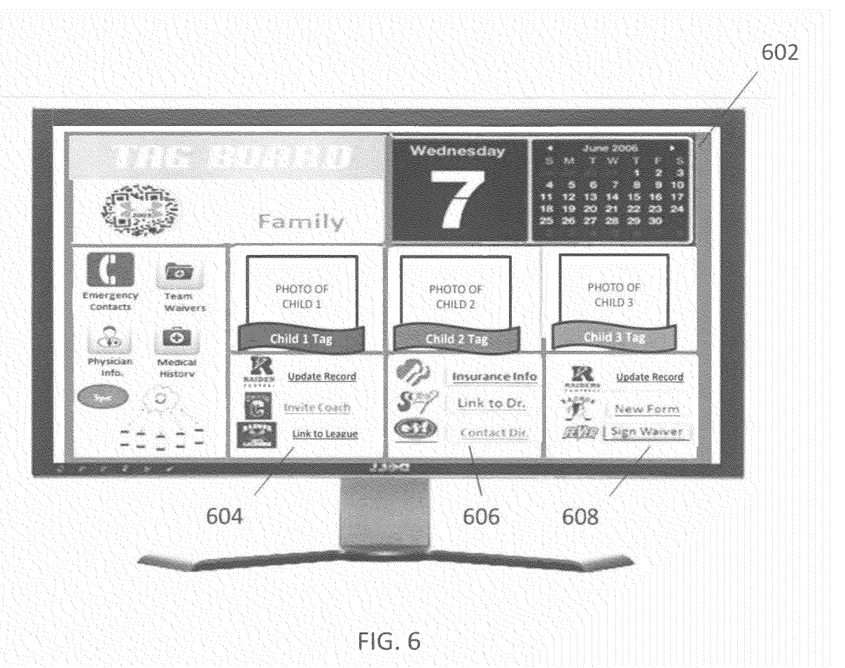

FIG. 6 is a screen shot of a family homepage 602 for a family having multiple children tag users according to embodiments. Although the embodiment shown in FIG. 6 is a family homepage for multiple children, the safety tag network may display a home page for any group having multiple tag users, such as teams and groups. As described above, a person (e.g., user, parent, coach, and league official) having knowledge of the tag user's safety information may input the safety tag user's name and the user's safety information via a web site or mobile application using web based server 106. Accordingly, a parent may use the home page 602 to input safety information and update safety information. As shown in FIG. 6, the home page 602 may display summary pages 604, 606 and 608 for each child. Further, each of the summary pages 604, 606 and 608 may include selections to manage the family's safety tag home page 602. For example, the selections may include links to forms, league sites, insurance information, invitations (e.g., such as coach invitations or other people who may be invited to have access to the safety information), waivers, contact information and doctor sites. The family home page 602 provides a single place to input information, update information and manage each child. The page may also provide a survey to rate coaches.

In some embodiments, the medical information network communication method may include obtaining a safety tag. For example, to obtain a safety tag, a parent or guardian (herein after parent) may sign a child up for a sports league and provide medical information of the child, such as electronic medical records, insurance information and emergency contact information. A parent or guardian of a child may also fill out a waiver and the child may be assigned a uniquely identifiable safety tag number, which may be a portion of identifier 103. In some embodiments, a parent may receive an additional identifier (e.g., number) when multiple children are assigned a safety tag. Further, a tag board corresponding to the additional number may be used to display information for each child. In some embodiments, the same safety tag number assigned to a user (e.g., a child) may be used for different sport leagues. The embodiments described above include a child assigned to the safety tag number. Embodiments may, however, include assigning safety tag numbers to adults as well.

Although embodiments described herein refer to sports leagues, embodiments are not limited to sports. Embodiments may include safety tag networks for any group, organization, team, league, school, and the like. For example, embodiments may provide tags and tag networks for boy scouts, girl scouts, campers, and extreme tags for extreme sport athletes such as mudders, marathon runners, hikers, climbers, skiers etc.

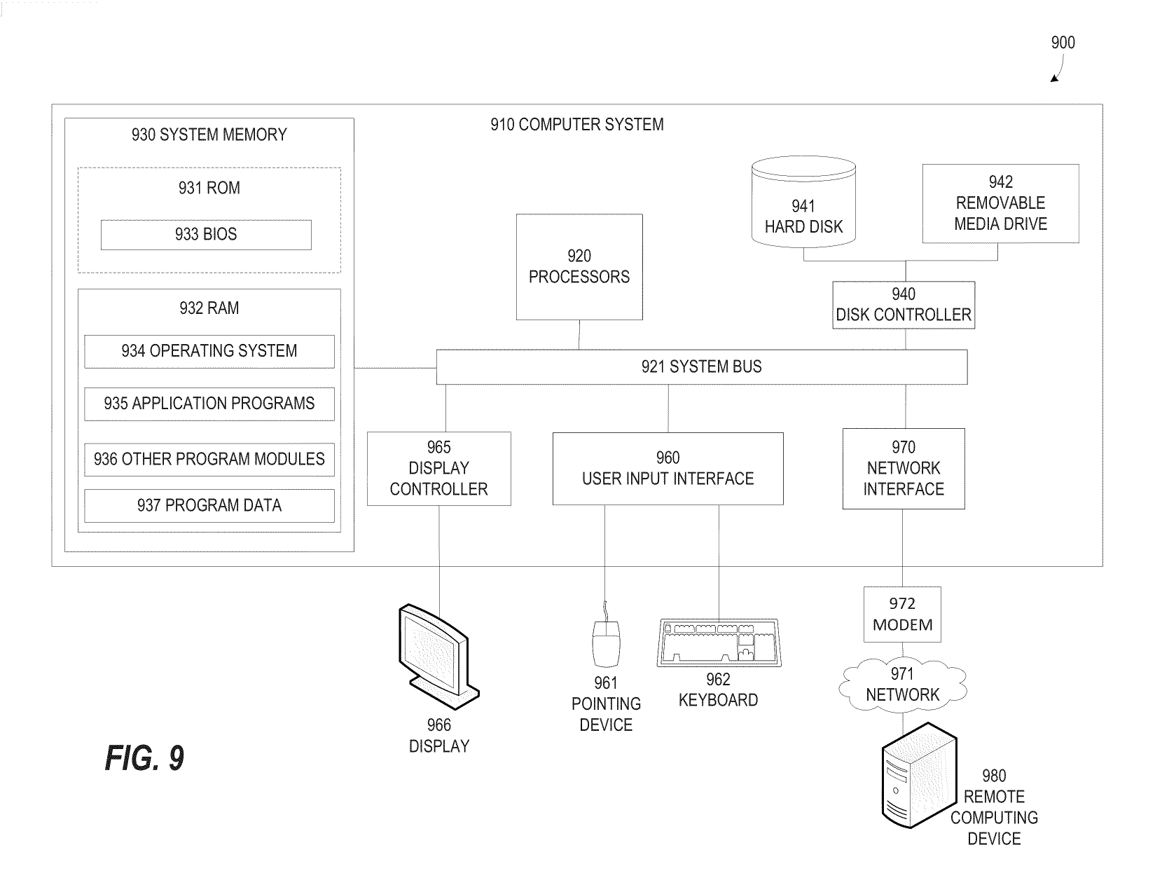

FIG. 9 illustrates an example of a computing environment 900 within which embodiments disclosed herein may be implemented. Computing environment 900 may include computer system 910, which is one example of a general purpose computing system upon which embodiments disclosed herein may be implemented. Computers and computing environments, such as computer 910 and computing environment 900, are known to those of skill in the art and thus are described briefly here.

As shown in FIG. 9, the computer system 910 may include a communication mechanism such as a bus 921 or other communication mechanism for communicating information within the computer system 910. The system 910 further includes one or more processors 920 coupled with the bus 921 for processing the information. The processors 920 may include one or more CPUs, GPUs, or any other processor known in the art.

The computer system 910 also includes a system memory 930 coupled to the bus 921 for storing information and instructions to be executed by processors 920. The system memory 930 may include computer readable storage media in the form of volatile and/or nonvolatile memory, such as read only memory (ROM) 931 and/or random access memory (RAM) 932. The system memory RAM 932 may include other dynamic storage device(s) (e.g., dynamic RAM, static RAM, and synchronous DRAM). The system memory ROM 931 may include other static storage device(s) (e.g., programmable ROM (PROM), erasable PROM, and electrically erasable PROM). In addition, the system memory 930 may be used for storing temporary variables or other intermediate information during the execution of instructions by the processors 920. A basic input/output system 933 (BIOS) containing the basic routines that help to transfer information between elements within computer system 910, such as during start-up, may be stored in ROM 931. RAM 932 may contain data and/or program modules that are immediately accessible to and/or presently being operated on by the processors 920. System memory 930 may additionally include, for example, operating system 934, application programs 935, other program modules 936 and program data 937.

The computer system 910 also includes a disk controller 940 coupled to the bus 921 to control one or more storage devices for storing information and instructions, such as a magnetic hard disk 941 and a removable media drive 942 (e.g., floppy disk drive, compact disc drive, tape drive, and/or solid state drive). The storage devices may be added to the computer system 910 using an appropriate device interface (e.g., a small computer system interface (SCSI), integrated device electronics (IDE), Universal Serial Bus (USB), or FireWire).

The computer system 910 may also include a display controller 965 coupled to the bus 921 to control a display or monitor 966, such as a cathode ray tube (CRT) or liquid crystal display (LCD), for displaying information to a computer user. The computer system includes an input interface 960 and one or more input devices, such as a keyboard 962 and a pointing device 961, for interacting with a computer user and providing information to the processor 920. The pointing device 961, for example, may be a mouse, a trackball, or a pointing stick for communicating direction information and command selections to the processor 920 and for controlling cursor movement on the display 966. The display 966 may provide a touch screen interface which allows input to supplement or replace the communication of direction information and command selections by the pointing device 961.

The computer system 910 may perform a portion or all of the processing steps of embodiments disclosed herein in response to the processors 920 executing one or more sequences of one or more instructions contained in a memory, such as the system memory 930. Such instructions may be read into the system memory 930 from another computer readable medium, such as a hard disk 941 or a removable media drive 942. The hard disk 941 may contain one or more datastores and data files used by embodiments disclosed herein. Datastore contents and data files may be encrypted to improve security. The processors 920 may also be employed in a multi-processing arrangement to execute the one or more sequences of instructions contained in system memory 930. In alternative embodiments, hard-wired circuitry may be used in place of or in combination with software instructions. Thus, embodiments are not limited to any specific combination of hardware circuitry and software.

As stated above, the computer system 910 may include at least one computer readable medium or memory for holding instructions programmed according to embodiments disclosed herein and for containing data structures, tables, records, or other data described herein. The term “computer readable medium” as used herein refers to any non-transitory, tangible medium that participates in providing instructions to the processor 920 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 941 or removable media drive 942. Non-limiting examples of volatile media include dynamic memory, such as system memory 930. Non-limiting examples of transmission media include coaxial cables, copper wire, and fiber optics, including the wires that make up the bus 921. Transmission media may also take the form of acoustic or light waves, such as those generated during radio wave and infrared data communications.

The computing environment 900 may further include the computer system 920 operating in a networked environment using logical connections to one or more remote computers, such as remote computer 980. Remote computer 980 may be a personal computer (laptop or desktop), a mobile device, a server, a router, a network PC, a peer device or other common network node, and typically includes many or all of the elements described above relative to computer 910. When used in a networking environment, computer 910 may include modem 972 for establishing communications over a network 971, such as the Internet. Modem 972 may be connected to system bus 921 via user network interface 970, or via another appropriate mechanism.

Network 971 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 910 and other computers (e.g., remote computing system 980). The network 971 may be wired, wireless or a combination thereof. Wired connections may be implemented using Ethernet, Universal Serial Bus (USB), RJ-11 or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 971.

Embodiments are not limited to those disclosed. Those skilled in the art will appreciate that numerous changes and modifications may be made to the preferred embodiments disclosed herein and that such changes and modifications may be made without departing from the true spirit of the embodiments disclosed herein. It is therefore intended that the appended claims be construed to cover all such equivalent variations as fall within the true spirit and scope of the embodiments disclosed herein.

1. A computer implemented safety tag network communication method, the method comprising:
receiving, from an electronic device, a first communication having identifier information identifying a tag user, the identifier information being disposed on a tag accompanying the tag user;
identifying, via a computer, one or more portions of safety information in a database associated with the identifier information disposed on the tag, the one or more portions of safety information being associated with the tag user;
retrieving, via a computer, the one or more portions of safety information associated with the tag user from the database;
transmitting, to the electronic device, a second communication having the one or more portions of safety information associated with the tag user; and
providing the one or more portions of retrieved safety information associated with the tag user at the electronic device.

2. The communication method of claim 1, further comprising:
associating, via the computer, the one or more portions of safety information with the identifier information; and
storing, in the database, the identifier information and the one or more portions of safety information associated with the identifier information.

3. The communication method of claim 1, wherein receiving the communication from the first electronic device further comprises a request for the one or more portions of the safety information associated with the tag user.

4. The communication method of claim 1, wherein the safety information associated with the tag user comprises at least one of electronic medical records, emergency contact information, physician contact information and insurance information.

5. The communication method of claim 1, wherein the safety tag identifier comprises at least one of the tag user's name and a safety tag identification number identifying the tag user.

6. The communication method of claim 1, wherein receiving the first communication having the identifier information further comprises receiving the identifier information obtained automatically from the tag by the electronic device.

7. The communication method of claim 6, wherein the safety tag identifier comprises a bar code and the identifier information is obtained automatically from the tag by the electronic device via the bar code.

8. The communication method of claim 6, wherein the safety tag identifier comprises radio frequency identification (RFID) and the identifier information is obtained automatically from the tag by the electronic device via the RFID.

9. The communication method of claim 1, wherein receiving the first communication having the identifier information further comprises receiving the identifier information manually input to the electronic device.

10. The communication method of claim 1, further comprising receiving the safety tag user's name and the one or more portions of safety information via a web based server.

11. A safety tag information network communication system comprising:
a safety tag configured to accompany a tag user and having identifier information disposed on a portion of the safety tag, the identifier information identifying the tag user;
an electronic device configured to transmit the identifier information via a network and present the one or more portions of tag user safety information associated with the identifier information;
a system server comprising:
(i) a receiving module configured to receive the identifier information from the electronic device;
(ii) a database interface module configured to retrieve the one or more portions of the tag user safety information associated with the identifier information; and
(iii) a transmitting module configured to transmit the one or more portions of the tag user safety information associated with the identifier information to the electronic device.

12. The system according to claim 11, wherein the electronic device further comprises a display module configured to display the one or more portions of the tag user safety information associated with the identifier information.

13. The system according to claim 11, further comprising an electronic database configured to hold the identifier information and the one or more portions of the tag user safety information associated with the identifier information.

14. The system according to claim 13, wherein the server further comprises a computer configured to identify the one or more portions of the tag user safety information associated with the identifier information in the electronic database.

15. The system according to claim 11, further comprising a web based server configured to:
receive the one or more portions of the safety tag user's name and the one or more portions of safety information; and
provide the one or more portions of the safety tag user's name and the one or more portions of safety information to the system server.

16. The system according to claim 11, wherein the server further comprises a computer configured to:
associate the one or more portions of safety information with the identifier information; and
cause the identifier information and the one or more portions of safety information associated with the identifier information to be stored in an electronic database.

17. A safety tag for use with a safety tag network communication system, the safety tag configured to accompany a safety tag user and comprising:
an identifier portion comprising identifier information that identifies the safety tag user and is associated with safety information of the safety tag user.

18. The safety tag of claim 17, wherein the identifier information comprises at least one of the safety tag user's name and a safety tag identification number identifying the tag user.

19. The safety tag of claim 17, wherein the identifier information comprises a bar code and the identifier information is obtained automatically from the tag by an electronic device via the bar code.

20. The safety tag of claim 17, wherein the identifier information comprises radio frequency identification (RFID) and the identifier information is obtained automatically from the tag by an electronic device via the RFID.
